(19) United States
(12) Patent Application Publication
(10) Pub. No.: US 2026/0080860 A1
(43) Pub. Date: Mar. 19, 2026

(54) Intelligent Voice Synthesis

(71) Applicant: Orange, Issy-Les-Moulineaux (FR)

(72) Inventors: Chantal GUIONNET, Chatillon Cedex (FR); Hélène JOUCLA, Chatillon Cedex (FR)

(21) Appl. No.: 19/110,040

(22) PCT Filed: Sep. 6, 2023
(86) PCT No.: PCT/EP2023/074378

§ 371 Date: Mar. 7, 2025

(30) Foreign Application Priority Data
Sep. 8, 2022 (FR) FR2209017

(51) Int. Cl. G10L 13/08; G10L 15/22

(52) U.S. Cl. CPC G10L 13/08; G10L 15/222

(57) ABSTRACT

A method for automatically reading a continuous text composed of several groups of words, as well as a corresponding computer program, storage medium, automatic reader, and user terminal. The method includes providing, in real time, a sound stream corresponding to the text. The sound stream starts from a selected group of words, also called second group of words, selected in the text as a function of at least one result of a real-time analysis of captured speech. The result of the analysis is indicative of a first group of words currently being verbalized by a speaker, the first group of words and the second group of words being different groups of words.

### CROSS-REFERENCE TO RELATED APPLICATIONS

This application is filed under 35 U.S.C. § 371 as the U.S. National Phase of Application No. PCT/EP2023/074378 entitled “Intelligent Voice Synthesis” and filed Sep. 6, 2023, and which claims priority to FR 2209017 filed Sep. 8, 2022, each of which is incorporated by reference in its entirety.

### BACKGROUND

### Field

The present disclosure relates to the field of voice synthesis.

More particularly, the present disclosure relates to a method for automatically reading a text, and to a corresponding computer program, storage medium, automatic reader, and user terminal.

### Description of the Related Technology

Text-to-Speech is a transformation or transcription of a written text into an audio rendering that corresponds to the same content. The type of voice and the speech rate can be configured.

If one wishes to make a synchronized audio mix between oral contributions from a user who is reading or presenting a text and voice synthesis contributions relating to this same text, one known possibility is to allow the user to trigger interruptions and resumptions of the voice synthesis at desired locations. Managing the audio alternation between human speech and voice synthesis relating to the same content may be carried out by human intervention. These interventions, using manual or spoken interactions for example, may trigger various functions: reading, pausing, stopping, or moving to the next or previous chapter.

Another known possibility is to implement a pre-established parameterization relating to a script prepared in advance. Such a parameterization can be described as semi-automated, since the parameterization is done by a human before the presentation, but no human intervention is then required during the presentation in order to activate the play, pause, stop, or other functions. One disadvantage of pre-established parameterization is the limited interactivity offered with the audience, since the speaker is forced to follow the script prepared in advance.

There is therefore a need for a truly automatic, even contextual, implementation of an audio alternation between human speech and voice synthesis relating to the same text, meaning without human intervention and without relying on any script prepared in advance.

### SUMMARY

The present disclosure improves the situation.

A method for automatically reading a continuous text composed of several groups of words is proposed, the method comprising a providing, in real time, of a sound stream corresponding to the text, the sound stream starting from a second group of words selected in the text as a function of at least one result of a real-time analysis of captured speech, the result of the analysis being indicative of a first group of words currently being verbalized by a speaker, the first group of words and the second group of words being different groups of words.

The continuous text may be a presentation, speech, narration, or other medium. It may be a text prepared in advance and written for example using a word processor. The continuous text may also result from automatically processing a screen capture or a photographic capture of a slide presented by a speaker, such automatic processing involving character recognition for example. A group of words may designate, for example, one or more sentences or one or more components of a sentence, for example one or more clauses.

It is understood that in the proposed method, the selected group of words, also called the second group of words, is the result of an automatic selection made in the continuous text.

The sound stream may be a simple or enhanced transcription of a portion of the continuous text, beginning with the selected group of words, also called the second group of words. According to one example of an enhanced transcription, the sound stream may include introductory words as a preamble, such as “to pick up where we left off”, “let's rewind a bit”, or “let me introduce myself, I am the Text-To-Speech assistant . . . ”.

The proposed method provides a voice synthesis rendering that is intelligent in that it automatically adapts to the flow of a speech or presentation. This intelligent rendering results from selecting a relevant second group of words as the starting point of the sound stream, this selection resulting from the real-time analysis of the words a user is currently speaking.

The features set forth in the following paragraphs may optionally be implemented. They may be implemented independently of each other or in combination with each other.

In one example, the providing of the sound stream is triggered if an interruption in the speaker's speech is detected. Detection of an interruption of speech refers to the detection of any explicit or implicit interaction on the part of the speaker, or any combination of such interactions, conveying that speaking has temporarily stopped. Silence, hesitation, or a particular posture are all examples of implicit interactions that can be captured and interpreted for the purposes of such detection.

In one example, the providing of the sound stream is interrupted if a resumption in the speaker's speech is detected. Detection of a resumption of speech refers to the detection of any explicit or implicit interaction by the speaker, or any combination of such interactions, reflecting a resumption of speech or the cessation of an interruption of speech. Real-time analysis of captured words, alone or combined with other real-time analyses, may for example allow detecting speech interruptions and resumptions.

When the two examples above are combined, the voice synthesis is able to take over automatically in the event of an impromptu and temporary speech interruption, until the speaker subsequently resumes speaking.

In one example, the selected group of words, also called the second group of words, is, in the text, identical to or consecutive to the group of words currently being verbalized by the speaker, also called the first group of words.

Real-time analysis of the captured speech may, for example, allow determining not only a group of words currently being verbalized. When the group of words currently being verbalized includes several words, the analysis also allows indicating whether this group of words has been fully verbalized or whether, on the contrary, it remains only partially verbalized. Fully verbalized is understood to mean that the user has spoken all the words in this first group of words, and partially verbalized is understood to mean that the user has spoken at least one word in this second group of words but not all the words in this second group of words. Such an indication may have an impact on both the result of the analysis, in which the first group of words will be, respectively, the group of words currently being verbalized that have been fully verbalized or the group of words that have been fully verbalized preceding the group of words that have been partially verbalized, and on the selected second group of words with which to begin the voice synthesis.

To illustrate this point, the example of triggering voice synthesis after detecting a speech interruption is now revisited. If the speech interruption occurs during verbalization, which remains partial, of a group of words comprising several words, it may be desirable for the analysis to indicate that the first group of words is the group of words preceding the partially verbalized group of words, and to begin the voice synthesis with a complete repetition of this same partially verbalized group of words which therefore constitutes the second group of words. If, conversely, the speech interruption occurs just after the complete verbalization of a first group of words and just before beginning the verbalization of a second immediately consecutive group of words, then it may be desirable to begin the voice synthesis directly with uttering this second group of words.

In one example, the result of the real-time analysis is indicative of several first groups of words successively verbalized by the speaker, and the selected group of words, also called the second group of words, is identical to or consecutive to the group of words closest to the end of the text among the first groups of words having been verbalized or currently being verbalized by the speaker.

It is common, for example, for identical or similar clauses to be repeated in different sentences, or for identical or similar sentences to be repeated in different passages of a same text. Choosing to start the voice synthesis with the second group of words following the last group of words similar to the first group of words being verbalized, among those having already been verbalized by the speaker, makes it possible to avoid repetitions likely to annoy the audience.

In one example, the method is implemented during a session and the selected group of words, also called the second group of words, is a group of words not appearing in the speech captured during the session and/or not appearing in a sound stream provided during the session prior to implementation of the method.

It is thus possible, for example, to begin the voice synthesis with the group of words positioned first in the text that has neither been verbalized by the speaker nor been the subject of a previous voice synthesis during the session. This makes it possible to reproduce the entire content of the text while avoiding any repetition.

A computer program is also provided, comprising instructions for implementing the above method when this program is executed by a processor.

A non-transitory computer-readable storage medium is also provided, on which is stored a program for implementing the above method when this program is executed by a processor.

An automatic reader is also proposed, comprising a provider of a sound stream in real time,
the sound stream corresponding to a continuous text composed of several groups of words,
the sound stream starting from a selected group of words, also called a second group of words, selected in the text as a function of at least one indication of a first group of words currently being verbalized by a speaker, the indication coming from a real-time analyzer of captured speech.

A user terminal is also proposed, comprising a provider of a sound stream in real time and a sound card, the provider being connected to the sound card and capable of providing a sound stream to the sound card, the sound stream corresponding to a continuous text composed of several groups of words,
the sound stream starting from a selected group of words, also called a second group of words, selected in the text as a function of at least one result indicative of a first group of words currently being verbalized by a speaker, the result coming from a real-time analyzer of captured speech.

In one example, the sound card is connected to one or more loudspeakers among the following: a loudspeaker of the user terminal, a loudspeaker of a device connected to the user terminal via a local area network.

The connections between the sound card and the loudspeaker(s) may be wired or via radio communication.

In one example, the user terminal further comprises a text display.

In one example, the user terminal further comprises a real-time word processing device capable of highlighting a group of words in the text based on the result and of providing the text with the highlighted group of words to the display.

Providing both the sound stream and the text with the highlighted group of words, in real time, enhances the accessibility of the presentation.

### BRIEF DESCRIPTION OF THE DRAWINGS

Other features, details and advantages will become apparent upon reading the detailed description below, and upon analysis of the attached drawings, in which:

FIG. 1 represents a sequence in a manually triggered audio alternation between human speech and voice synthesis relating to a same content.

FIG. 2 illustrates, in a flowchart, a method for automatically reading a text, according to one exemplary embodiment.

FIG. 3 represents a set of data considered in succession in order to carry out an automatic audio transition from human speech to voice synthesis relating to a same content, according to one particular exemplary embodiment.

FIG. 4 represents a sequence in an automatic audio alternation between human speech and voice synthesis relating to a same content, according to the particular embodiment of FIG. 3.

FIG. 5 represents a set of data considered in succession in order to carry out an automatic audio transition from human speech to voice synthesis relating to a same content, according to one set of particular exemplary embodiments.

FIG. 6 and FIG. 7 each represent a sequence in an automatic audio alternation between human speech and voice synthesis relating to a same content, according to two examples from the set of particular exemplary embodiments of FIG. 5.

### DETAILED DESCRIPTION OF CERTAIN ILLUSTRATIVE EMBODIMENTS

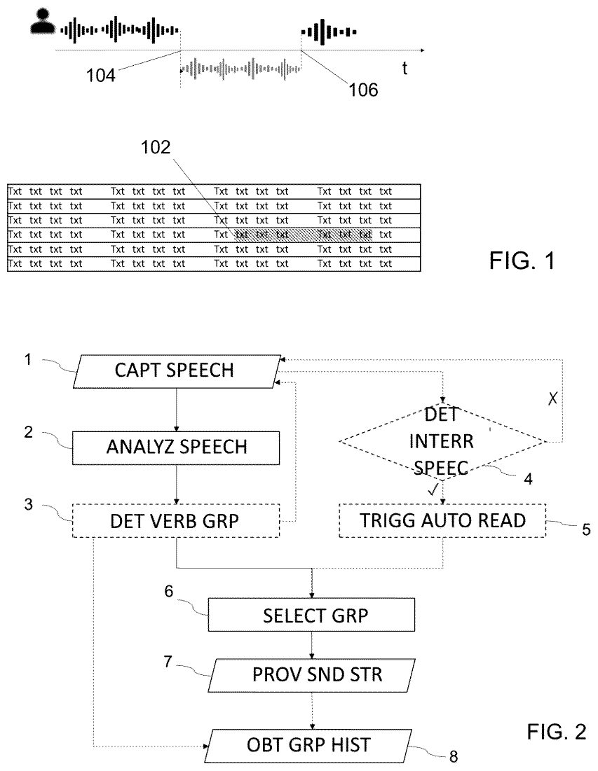

It is known to control a method of voice synthesis by means of manual actions. FIG. 1 is an illustrative example of the prior art where an action of positioning (102) in the text may be combined with an action of launching (104) voice synthesis in order to begin emitting an audio signal starting at a desired location in the text. An action of pausing or stopping (106) the voice synthesis may subsequently allow stopping the emission of the audio signal, at another desired location.

The development differs from the prior art and aims to intelligently mix the speaking by the speaker, who reads or presents from a text medium, with appropriate parts of the same text rendered by voice synthesis.

Automatic and real-time coverage during audio presentations makes it possible to hand over to voice synthesis based on the moment-by-moment progression of the presentation.

These handovers offer various benefits for the experience shared by the speaker and his audience.

For example, the choice of a synthesized voice that is different from the speaker's voice makes it possible to simulate contributions by a second speaker and thus to obtain a two-voice effect.

The speaker may also be replaced in the event of difficulty speaking for long periods, forgetting the text, stress, shortness of breath, external disruptions such as a telephone call, etc. Selecting a synthesized voice that is identical to the speaker's voice can prevent the audience from detecting the substitution.

One particular exemplary embodiment is now described with reference to FIG. 2 which visually represents an algorithm corresponding to a method for automatically reading a text.

During a session corresponding to a presentation, a speech, or any other event involving audio reproduction of a text medium, the words of one or more human speakers are captured (1) by means of one or more microphones.

These words are analyzed (2) in real time by an analyzer which implements a voice recognition algorithm. Such algorithms are well known to the person skilled in the art and are not detailed here.

The real-time analysis of the captured words allows determining (3), at any moment, a first group of words currently being verbalized by a speaker. The first group of words currently being verbalized may be found verbatim in the text medium. It may also be a variation that can be equated to a first group of words present in the text medium. Lastly, it may be a digression initiated by the speaker, meaning at least one group of words accompanying the audio presentation of the text but which is not comparable to any particular group of words in the text medium.

The first group of words being verbalized may be stored in memory. Storing in memory the groups of words successively being verbalized throughout a speaker's contributions corresponds to forming a history of the groups of words that have been verbalized. When the speaker's intervention deviates from the text medium, it may be useful to automatically process the history by comparing it with the text medium so that, among the groups of words that have been verbalized, only those groups of words which either actually appear in the text or are equivalent to groups of words which actually appear in the text are considered. Obtaining (8) such a history therefore makes it possible to identify, at any moment during a speaker's intervention, the groups of words in the text that have already been verbalized, verbatim or not, by the speaker, the group currently being verbalized by the speaker, and finally those groups in the text that remain to be verbalized.

The result of the real-time analysis of the captured speech is used to select (6) a position in the text, meaning a second group of words in the text, from which to begin a voice synthesis of the rest of the text. The logical link between the result of the analysis of the captured speech and the selected group of words, also called the second group of words, is explained through several examples in the remainder of this document.

Voice synthesis may then be implemented, and a sound stream corresponding to the result of the voice synthesis may be provided (7), for example in the form of a digital signal intended to be reproduced by one or more loudspeakers.

In addition, the groups of words in the text that have been the subject of voice synthesis can be identified as such and can be stored in the history of the verbalized groups of words. Obtaining (8) such a history thus makes it possible to identify, at any time during the session, the groups of words in the text that have already been verbalized or are in the process of being verbalized either by the speaker or by voice synthesis and those that remain to be verbalized.

In the example of FIG. 2, it is optionally provided not to implement automatic reading while the speaker is speaking and to trigger (5) automatic reading when an interruption in the speaker's speech is detected (4).

In general, it is possible to define pre-established situations and to provide for triggering, or interrupting, an automatic reading upon detection of such a pre-established situation. The speech interruption here represents one particular example of a pre-established situation usable as a trigger for automatic reading. Correspondingly, a speech resumption can represent an example of a pre-established situation which, when detected, causes an interruption in the automatic reading.

A pre-established situation may be detected (4) by interpreting data from one or more sensors. These data may be indicative of an interaction or of a set of interactions of the speaker. These interactions may be explicit or implicit.

Various examples of data which can be captured and interpreted so as to lead to detecting a pre-established situation are now provided.

Background noise, a technical failure of the speaker's microphone, or a loss of connection are examples of incidents relating to speech capture. Such incidents are detectable by various known technical means and correspond to an inability to reproduce the speaker's words, which may constitute one example of a pre-established situation.

Silence or a significant slowdown in the speech rate are examples of implicit interactions of the speaker that can be detected by low-level analysis of the captured speech. These examples of implicit interactions are indicative of a time period during which no group of words is being verbalized by the speaker, which corresponds to a literal interruption of speech by the speaker. Voice synthesis may be triggered for example by comparing the duration of this time period with a configurable threshold, on the order of a few seconds for example. Below this threshold, the speech interruption is considered to be a normal pause in talking that does not justify a handover to voice synthesis, and, conversely, above this threshold, the speech interruption is considered too long and a handover to voice synthesis is carried out automatically.

Other thresholds for triggering or interrupting voice synthesis may be defined, on a case-by-case basis, depending on the nature of the captured data and/or the results of the analysis of the captured data. These thresholds may be set manually or automatically.

For example, setting a threshold relating to the duration of a pause in the talk, determined by analyzing the captured speech, may be based on the results of past analyses of speech by the speaker concerned and/or based on criteria relating to a desired quality of audio reproduction.

A stutter, a hesitation, or more generally an indication of fatigue or lack of intelligibility, as well as a digression, are other examples of implicit interactions by the speaker. These examples of implicit interactions can be detected by voice recognition and can be interpreted as known or desired interruptions in the speaker's oral presentation of the text medium. When, for example, detected hesitations exceed a certain frequency threshold during a given time period, then voice synthesis may take over automatically in order to avoid stressing the speaker.

In parallel with the speaker's words, it is possible to capture other types of data in real time. Images from a video of the speaker captured by a camera during the session are one example of data that can be analyzed in real time, and the result of such an analysis can make it possible to detect events corresponding to predetermined situations. Detection of an event may be based for example on indications relating to a movement of the speaker, such as a lip movement, a change in the direction of his gaze, a rotation of the head, a gesture, a change in posture, a shift in location, etc.

Certain predetermined situations may simply correspond to receiving one or more explicit instructions from the speaker, for example by the speaker interacting with a display element or a button provided for this purpose, or by a gesture of the speaker that is detectable for example by a motion sensor, or by a voice instruction from the speaker that is detectable by voice recognition.

It is understood that the proposed technique is not limited to embodiments where automatic reading is triggered by an event occurring during the session.

To illustrate this point, in one example, the sound stream corresponding to the captured speech and the sound stream corresponding to the voice synthesis may be automatically provided continuously throughout the duration of the session, for example in the form of two separate tracks each intended to be rendered exclusively. No triggering of automatic reading is therefore imposed in this example. It should be noted, however, that providing the voice synthesis track requires an underlying mechanism for automatic synchronization of the words read in voice synthesis with those read by the speaker, in order to preserve harmony and fidelity in the speech in real time. The details of such a mechanism are not discussed in this document.

The possibility of switching from one track to another may be provided for example by means of manual interactions and/or automatically, depending on the flow of the session.

The sound stream corresponding to voice synthesis may also be modified in real time according to the result of the analysis of the captured words. The modification may in particular include selecting, in the text, a second group of words to be rendered by voice synthesis, corresponding to the group currently being verbalized by the speaker. This is therefore an adaptation of the voice synthesis track via groups of words consistent with the groups of words successively being read by the speaker.

The aim in such an example is to offer automatic and real-time voice synthesis of the speaker's contributions while ensuring that the groups of words thus synthesized are consistent with those in the text medium.

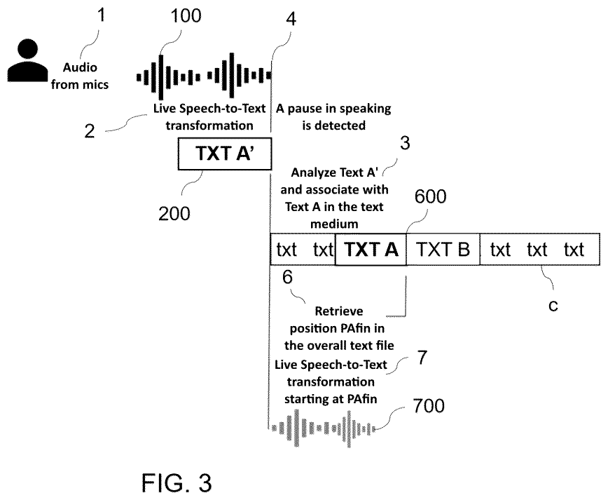

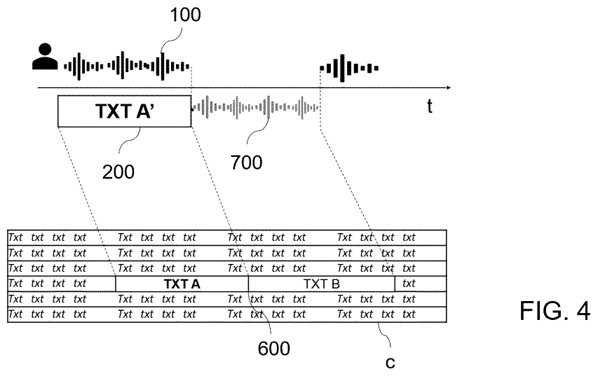

Reference is now made to FIGS. 3 and 4 which refer to the same specific example. FIG. 3 illustrates a logical path for selecting a second group of words with which to begin a voice synthesis. FIG. 4 illustrates a sequence in an automatic audio alternation between the words of a speaker and a voice synthesis beginning with the second group of words thus selected.

In this example, it is considered that a speaker had been speaking during a session, voicing at least the content of a text medium “c”. The text medium is conceptually divided into consecutive parts denoted “Txt A”, “Txt B”. each formed of one or more groups of words, the parts “Txt A”, “Txt B”. of the text medium thus corresponding to clauses, sentences, or passages composed of several sentences.

The speaker's words (100), denoted “Audio A”“, are captured (1) and analyzed (2) in real time. At a given moment, the analysis of the captured words comprises a real-time transcription of a first group of words being verbalized, the result of which is a piece of text denoted ”Txt A“”(200) and an interpretation of the transcription thus obtained.

The analysis makes it possible to establish (3) a correspondence between the captured words “Audio A”and at least one part “Txt A”of the text medium “c”.

In the ideal case where the speaker reads his text exactly, the correspondence is fast and easy. In other cases, such as during presentations on a given subject, the speaker may use synonyms, add or remove words, and add or remove details or clarifications.

The correspondence may be obtained by comparing the result of the transcription with the text medium. A given piece of text “Txt A”“ may for example be associated with a given part ”Txt A“ of the text medium, by detecting a similarity or by detecting the inclusion of one in the other (i.e. the inclusion of ”Txt A“” in “Txt A” or conversely the inclusion of “Txt A”in “Txt A”).

When a speech interruption, i.e. a pause by the speaker, is detected (4) at a given moment, the established correspondence makes it possible to determine (6) a location (600) the speaker has reached in the text. In other words, the established correspondence makes it possible to identify the next group of words in the text to be uttered in order to continue the speech in a coherent manner.

If the pause occurred abruptly in the speech, for example in the middle of a sentence, the next group of words to be uttered, also called the second group of words, may be the group of words partially verbalized by the speaker at the time of the pause. If the pause occurred more harmoniously in the speech, for example after the end of a sentence, the next group of words to be uttered, also called the second group of words, may be the group of words following the first group of words last verbalized by the speaker.

To ensure that voice synthesis takes over after the speaker has paused, a sound stream (700) is provided (7), this sound stream starting with part “Txt B” of the text medium comprising the next group of words to be uttered, also called the second group of words. It may be provided that, by default, this sound stream continues automatically until the end of the text medium. It may also be provided that the sound stream is automatically interrupted if a resumption of speech by the speaker is detected.

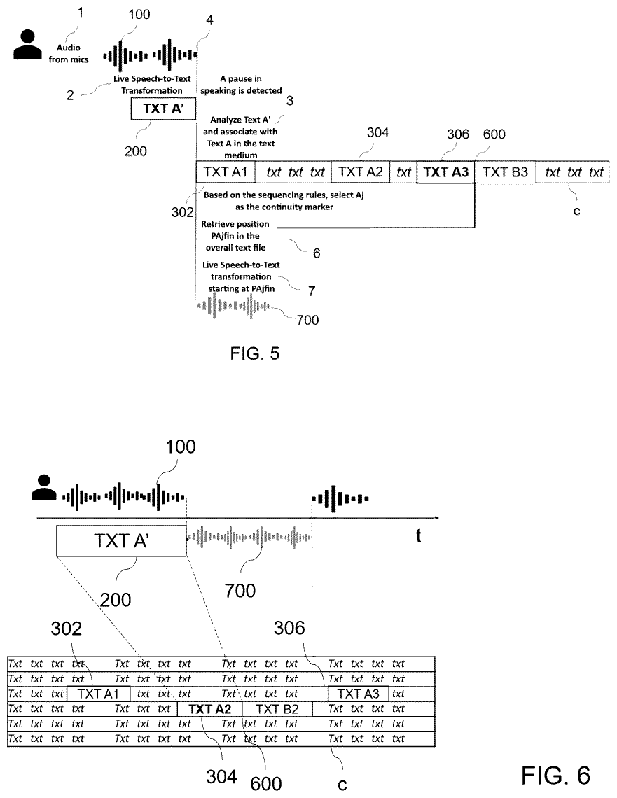

Reference is now made to FIGS. 5, 6 and 7 which illustrate a set of particular, more complex examples, where a text medium comprises repetitions of a same group of words during verbalization.

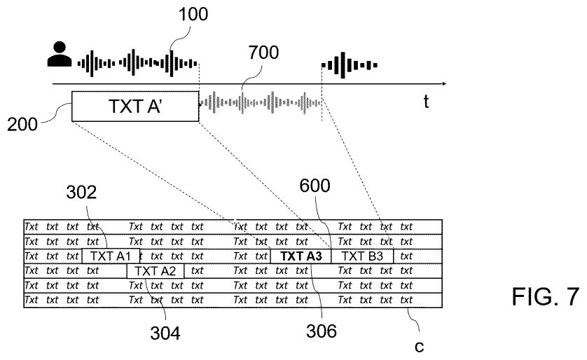

FIG. 5 illustrates a logical path for selecting a second group of words with which to begin voice synthesis in these more complex cases. FIGS. 6 and 7 each illustrate a sequence in an automatic audio alternation between the words of a speaker and a voice synthesis that begins with a second group of words thus selected.

As in the example of FIGS. 3 and 4, the speaker's words (100), denoted “Audio A′”, are captured (1) and analyzed (2) in real time.

At a current given time, the analysis of the captured words comprises a real-time transcription of a first group of words being verbalized, the result of which is a piece of text denoted “Txt A′” (200) and an interpretation of the transcription thus obtained.

To implement an automatic handover to voice synthesis, for example starting from the current time, it is appropriate to select automatically the next group of words to be spoken, also called the second group of words, and different settings may be retained for this purpose.

In the set of examples of FIGS. 5, 6 and 7, the piece of text “Txt A′” (200) is first associated (3), due to similarity or inclusion, with several parts of the text medium, for example three parts denoted “Txt A1” (302), “Txt A2” (304), and “Txt A3” (306). It is also assumed, in each of these examples, that the speaker does not read the content, also called text medium “c”, in a linear manner. Thus, parts “Txt A1”, “Txt A2” and Txt A3” are included in this order in the person's presentation, meaning that the speaker first reads part “Txt A1” then “Txt A2” and finally “Txt A3”. On the other hand, the order of appearance of the parts in the content “c” is different. Thus, parts “Txt A1”, “Txt A3”, and “Txt A2” appear in this order in the content c, meaning that a reader such as the speaker or the automatic reader which reads content “c”linearly would first read part “Txt A1”, then “Txt A3”, and finally “Txt A2”.

Parts “Txt A1” (302), “Txt A2” (304), and “Txt A3” (306) are different and are distributed discontinuously in the text medium, i.e. they cannot be merged into a single continuous part of the text medium. In this case, to ensure a handover to voice synthesis, in particular following a detected pause (4) by the speaker, a sound stream (700) is provided, this sound stream starting with part “Txt B3” of the text medium comprising the next group of words to be spoken, also called the second group of words, following part “Txt A3”, also called the first group of words, associated with the text “Txt A” verbalized by the speaker. According to this definition, parts “Txt A3” (first group of words) and “Txt B3” (second group of words) may be contiguous. Alternatively, parts “Txt A3” and “Txt B3” may overlap very slightly, i.e. include a common group of words corresponding to a group of words whose verbalization was interrupted by the speaker's pause. It may be provided that, by default, this sound stream continues automatically until the end of the text medium. It may also be provided that the sound stream is automatically interrupted if a resumption of speech by the speaker is detected.

This association may fall under two other different scenarios. In these two other scenarios, the result of the association does not allow identifying with certainty the part of the text medium currently being orally presented by the speaker, but only allows identifying several candidates, which in this example are the three different parts “Txt A1” (302), “Txt A2” (304), and “Txt A3” (306) in the text medium “c”. In these two cases, the words “Txt A” of the speaker were spoken temporally in the following order: “Txt A1” followed by “Txt A2” and finally “Txt A3”. Analysis (2) therefore finds, from “Txt A′”, the three groups of words “Txt A1”, “Txt A2” and “Txt A3” forming part of the reference speech (in the text medium “c”).

Note, as already indicated above:
“Txt A2” corresponds to the group of words furthest in position in the reference text or text medium “c”, but does not correspond to the first group of words last uttered by the speaker;
“Txt A3” corresponds to the first group of words last spoken by the speaker but is positioned upstream in the reference text or text medium “c”. This may correspond to the fact that the speaker forgot (skipped) the group of words “Txt A3” and went from “Txt A1” to “Txt A2” then realized his omission and verbally continued with “Txt A3”, which does not correspond to the order in the reference text “c”.

In a first case illustrated in FIG. 6, the selection of the next group of words to be voice synthesized, also called the second group of words, may be the group of words that first follows the part closest to the end of the text medium, here “Txt A2”. This selection makes it possible to avoid repetitions even if this means not reproducing the entire text medium. For example, the speaker reads the content “c”; sensors such as microphones provide a captured audio signal 100; a real-time transformation of speech into text, in particular voice recognition, generates the text 200 corresponding to the captured audio 100. Analysis of the content “c” makes it possible to determine that the text “Txt A” uttered by the speaker potentially corresponds to one or more parts of the content “c”, in this case in the order spoken, to parts 302, 304 and 306, since the speaker does not read the content c in the order written but first reads parts 302 followed by 304 and returns to part 306 (positioned before 304 in the text medium c). In the example of FIG. 6, the interruption in the speaker's reading is estimated to correspond to the end of the most distant part in the text medium c, in this case part 304 triggering the start of voice synthesis with the beginning of part B2. Optionally, at a given moment during voice synthesis of the content “c”, the speaker may resume reading, thus interrupting the voice synthesis. This marks the end of part B2.

In a second case illustrated in FIG. 7, the selection of the next group of words to be uttered, also called the second group of words, may be the group of words appearing first after the last part 306 associated with the text medium being orally presented by the speaker, here “Txt A3”. This selection ensures continuity in the speech, but at the risk of causing repetitions. For example, the speaker reads the content “c”; sensors such as microphones provide a captured audio signal 100; a real-time transformation of speech into text, in particular voice recognition, generates the text 200 corresponding to the captured audio 100. Analysis of the content “c” allows determining that the text “Txt A′” uttered by the speaker potentially corresponds to one or more parts of the content “c”, in this case, in the order spoken, to parts 302, 304 and 306 because the speaker, having skipped passage 306 before reading passage 304, will read it afterwards. In the example of FIG. 7, the interruption in the speaker's reading is estimated to correspond to the end of part 306, triggering the start of voice synthesis with the beginning of part B3. Optionally, at a given moment during voice synthesis of the content “c”, the speaker may resume reading, thus interrupting the voice synthesis. This marks the end of part B3, which may then possibly overlap or include part 304.

It is also possible to take into account all parts of the text already described, by means of a history of captured speech and/or of content previously provided by voice synthesis, in order to choose the next group of words to be uttered, also called the second group of words.

Three particular exemplary applications of the proposed technique are now described for illustrative purposes.

In a first example, Pierre has planned to make a presentation with his colleague Paul, which they have they prepared together, taking turns speaking in order to have a better dynamic but also because each is a bit more specialized in certain aspects. Unfortunately, at the last moment, Paul is unable to be present and to assist. Pierre provides the medium for the presentation in the form of a text file, to an automatic reading service which makes use of an implementation of the proposed automatic reading technique. Pierre thus feels reassured and will not hesitate to take a break at any time, knowing that the service will take over.

In a second example, Jeanne uses a microphone to narrate a presentation of her latest tutorial video, in a conference room with her colleagues. During the presentation, she receives a message or a call on her phone that requires an immediate response. She cannot interrupt the video in progress, and it is obviously preferable that the speech not be interrupted. She leaves for a moment into the next room in order to make a brief telephone call. During this time, according to one implementation of the proposed technique, a service automatically detects that Jeanne is no longer speaking into the microphone and activates a handover to a voice synthesis module to play the rest of the planned speech. Thus, the listeners engaged by the video are practically unaware of the replacement, especially since Jeanne had configured the synthesis voice to be a clone of her own. As soon as she returns and picks up the microphone once again, the voice synthesis automatically stops, and Jeanne continues her explanations.

In a third example, Rose is giving a presentation despite a sore throat, having previously activated a service in the background that implements an embodiment of the proposed technique. For the first 15 minutes everything goes well, then her throat starts to be irritated and she can no longer express herself as easily as she would like. With a click, she activates the voice synthesis while she recovers. She feels less embarrassed and can resume whenever she wants.

1. A method for automatically reading a continuous text composed of several groups of words, the method comprising providing, in real time, a sound stream corresponding to the text, the sound stream starting from a selected group of words, also called a second group of words, selected in the text as a function of at least one result of a real-time analysis of captured speech, the result of the analysis being indicative of a first group of words currently being verbalized by a speaker, the first group of words and the second group of words being different groups of words.

2. The method according to claim 1, wherein the providing of the sound stream is triggered if an interruption in the captured speech is detected.

3. The method according to claim 2, wherein the providing of the sound stream is interrupted if a resumption in the captured speech is detected.

4. The method according to claim 1, wherein the selected group of words, also called the second group of words is, in the text, identical to or consecutive to the group of words currently being verbalized by the speaker, also called the first group of words.

5. The method according to claim 1, wherein the result of the real-time analysis is indicative of several groups of words successively verbalized by the speaker, and the selected group of words, also called the second group of words, is identical to or consecutive to a group of words closest to an end of the text among groups of words having been verbalized or currently being verbalized by the speaker.

6. The method according to claim 1, wherein the method is implemented during a session and the selected group of words, also called the second group of words, is a group of words not appearing in the speech captured during the session and/or not appearing in a sound stream provided during the session prior to implementing of the method.

7. (canceled)

8. A non-transitory computer-readable storage medium on which is stored a program for implementing the method according to claim 1 when this program is executed by a processor.

9. An automatic reader comprising a provider of a sound stream in real-time,
the sound stream corresponding to a continuous text composed of several groups of words,
the sound stream starting from a selected group of words, also called a second group of words, selected in the text as a function of at least one indication of a first group of words currently being verbalized by a speaker, the indication coming from a real-time analyzer of captured speech.

10. A user terminal comprising a provider of a sound stream in real time and a sound card,
the provider being connected to the sound card and capable of providing a sound stream to the sound card, the sound stream corresponding to a continuous text composed of several groups of words,
the sound stream starting from a selected group of words, also called a second group of words, selected in the text as a function of at least one result indicative of a first group of words currently being verbalized by a speaker, the result coming from a real-time analyzer of captured speech.

11. The user terminal according to claim 10, wherein the sound card is connected to one or more loudspeakers among the following: a loudspeaker of the user terminal, a loudspeaker of a device connected to the user terminal via a local area network.

12. The user terminal according to claim 10, further comprising a text display.

13. The user terminal according to claim 12, further comprising a real-time word processing device capable of highlighting a group of words in the text based on the result and of providing the text with the highlighted group of words to the display.
